(19) United States
(12) Patent Application Publication
(10) Pub. No.: US 2009/0311537 A1
(43) Pub. Date: Dec. 17, 2009

(54) INSULATING PASTE FOR LOW TEMPERATURE CURING APPLICATION

(75) Inventor: AKIRA INABA, Kawasaki-Shi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/483,362

(22) Filed: Jun. 12, 2009

Related U.S. Application Data
(60) Provisional application No. 61/061,161, filed on Jun. 13, 2008.

(51) Int. Cl. B32B 17/10; C08L 83/00; C08K 3/34; C08K 3/22; C08K 3/28; C08K 3/38; B32B 27/20

(52) U.S. Cl. 428/429; 524/588; 524/449; 524/451; 524/447; 524/445; 524/413; 524/430; 524/428; 524/442; 524/456; 524/404; 428/447

(57) ABSTRACT

This invention relates to an insulating paste for an electric module that avoids cracks occurring in an insulating layer. The insulating paste comprises heat-curable silicone resin, inorganic filler and solvent.

### FIELD OF THE INVENTION

The present invention relates to an insulating paste used in making an electronic module.

### TECHNICAL BACKGROUND

In order to guarantee satisfactory operation of electrical equipment, it is necessary to control electrical connections in an electronic module. Connections are typically controlled according to the design of the insulating sections and electrically conducting sections in electronic components or modules. An insulating paste is used for the insulating sections. For example, electric modules have a structure in which insulating paste is coated to a thickness of several tens of microns followed by baking or curing and then mounting an electrical circuit or electronic component on the insulating layer. Here, an organic resin or glass fritt is mainly used for the binder of the insulating paste used to form the insulating layer, and these are used according to the type of substrate. Since inorganic substances are more preferable than organic substances for adhering to inorganic substrates, glass fritt is used for inorganic substrates. For example, the same inorganic glass is used as a binder in insulating layers formed on an inorganic substrate such as a glass substrate, metal substrate or ceramic substrate. Organic resins are used for the insulating layers formed on organic substrates such as resin substrates containing polyimide and the like. JP2007-042291 discloses an insulating paste that comprises glass and metal oxide such as Al2O₃, CaZrO₃, BaZrO₃, MgZrO₃, and SrZrO₃. JP2002-226675 discloses an insulating paste which comprises liquid epoxy resin, silica powder and organophosphate ester for use on a polyimide substrate. WO2007108550 discloses an insulating composition comprising epoxy resin, inorganic fine particles and/or organic fine particles, and fluorine-containing polyether. US2005224767, JP 2003-234019, discloses dielectric composition or an insulating paste comprising epoxy resin. JP 2005-330505, JP 2004-055345, JP H05-298916, and US2004132888 disclose an insulating layer composed of a silicon ladder based resin composition.

However, cracks sometimes occur in an insulating layer on an inorganic substrate due to different Thermal Coefficient Expansion (TCE) between an inorganic substrate and insulating layer. JP H05-190997 discloses insulating paste consisting of inorganic filler dispersed in epoxy resin in order to restrain generation of a curling in the insulating layer. JP2004-055345 discloses conductive paste which is prepared by using an organosilsesquioxane-system oligomer soluble in an organic solvent instead of glass fritt powder dispersed as a solid-phase constituent in paste, and by dispersing metal powder or the like of a conductive medium in a solution prepared by dissolving the organosilsesquioxane-system oligomer in an organic solvent. The conductive paste is fired under 800-900 degrees C.

It is desirable to prevent cracks from occurring in an insulating layer due to different TCE between an inorganic substrate and insulating layer. It is also desirable to improve upon the insulating layers using epoxy resin and to provide an insulating paste that can be cured at a low temperature and that can prevent from cracks in an insulating layer on an inorganic substrate after curing.

### SUMMARY OF THE INVENTION

The insulating paste of the present invention comprises heat-curable silicone resin, inorganic filler and solvent. This heat-curable silicone resin preferably contains functional groups of alkyl group having 1 to 10 carbon atoms or phenyl group. The amount of the heat-curable silicone resin is preferably 10 wt % up to 99 wt % based on the total weight of the silicone resin and the inorganic filler described above. The inorganic filler is preferably one or more types of inorganic selected from a group consisting of mica, talc, kaolinite (Al2Si2O5(OH)4), montmorillonite, titanic oxide (TiO₂), aluminum oxide (Al2O₃), aluminum nitride (AlN), zirconium dioxide (ZrO₂), silicon carbide (SiC), Silica (SiO₂), barium titanate (BaTiO3), geikielite (MgTiO₃), silicon carbide (SiC), Silica (SiO₂), barium titanate (BaTiO₃), geikielite (MgTiO₃), Tausonite (SrTiO₃) and Boron nitride (BN).

In another aspect of this present invention, an electric module comprises an inorganic substrate; an insulating layer formed on the inorganic substrate and comprising cured resin including polysiloxane skeleton and inorganic filler dispersed in the cured resin; and an electrode formed on the insulating layer. The insulating layer described above preferably covers an electrode. The electric module preferably comprises: a first insulating layer and a second insulating layer, wherein the first layer on the inorganic substrate comprises cured resin including polysiloxane skeleton and inorganic filler that is one or more of mica, talc or their mixture, and the second insulating layer on the first insulating layer comprises cured resin including polysiloxane skeleton and inorganic filler that is one or more of kaolinite (Al₂Si₂O₅(OH)₄), montmorillonite, titanic oxide (TiO₂), aluminum oxide (Al₂O₃), aluminum nitride (A1N), zirconium dioxide (ZrO₂), and silicon carbide (SiC), Silica (SiO₂), barium titanate (BaTiO₃), geikielite (MgTiO₃) and Tausonite (SrTiO₃). The insulating layer on the substrate preferably consists of first layer and second layer, wherein the first layer which lies on the inorganic substrate comprises cured resin including polysiloxane skeleton and inorganic filler that is one or more of mica, talc or their mixture, and the second insulating layer which lies on the first insulating layer comprises heat-curable silicone resin, solvent and inorganic filler that is one or more of kaolinite (Al₂Si₂O₅(OH)₄), montmorillonite, titanic oxide (TiO₂), aluminum oxide (Al₂O₃), aluminum nitride (AlN), zirconium dioxide (ZrO₂), and silicon carbide (SiC), Silica (SiO₂), barium titanate (BaTiO₃), geikielite (MgTiO₃) and Tausonite (SrTiO₃). The substrate is preferably one of an aluminum nitride substrate (AlN), an alumina substrate (AL₂O₃), a zirconia oxide substrate (ZrO), a mullite substrate (3A₂O₃.2SiO₂), steatite (MgO.SiO₂), a ceramic glass substrate of ferrite glass or a metal substrate of stainless, aluminum, aluminum alloy, nickel, nickelic alloy or cupper.

### BRIEF DESCRIPTION OF THE DRAWINGS

FIG. 1 is an overhead view of a printed electric module.

FIG. 2 is a cross-sectional view taken along line II-II of the printed electric module of FIG. 1

FIG. 3 is a cross-sectional view of LED package wherein encapsulation is done by use of the insulating paste of this present invention.

FIG. 4 is a cross-sectional view of flip chip wherein under-fill is made from the insulation paste of this present invention.

### DETAILED DESCRIPTION OF THE INVENTION

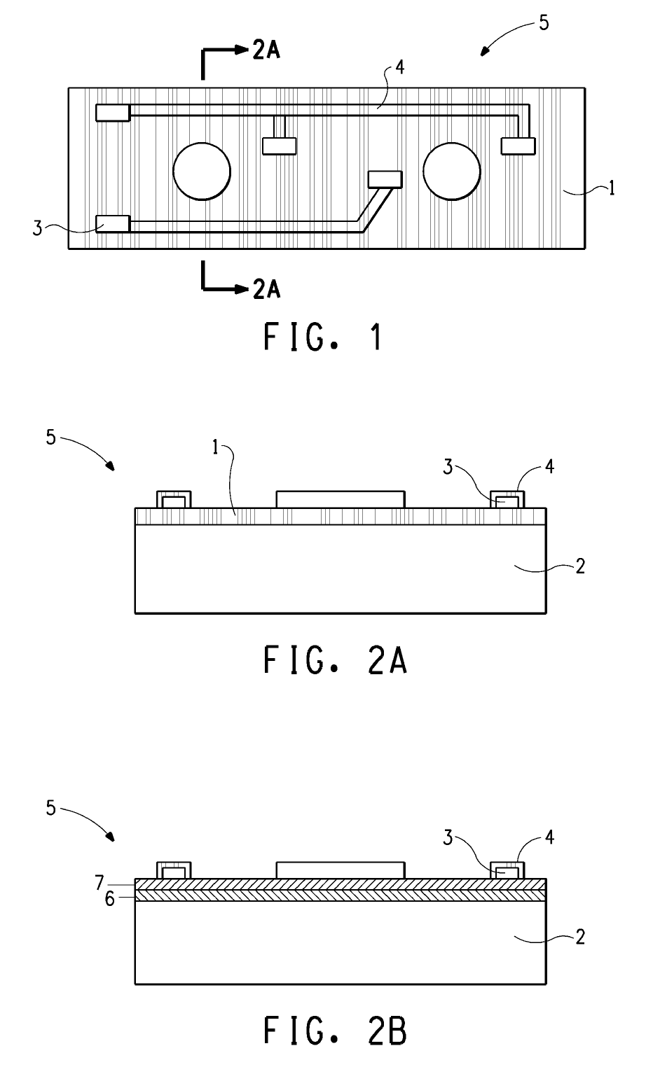

FIG. 1 and FIG. 2 describe a printed electric module with an insulating layer 1 on an inorganic substrate 2. An electrode 3 is on the insulating layer. The insulating paste may preferably be applied twice to get two layers on an inorganic substrate 2 (FIG. 2(b)). In this case, the first insulating layer 6 which is directly on a substrate 2 preferably includes mica that gives strength against TCE mismatch between insulating layer and the substrate. The second insulating layer 7 which is on the first layer preferably includes Al2O3 that gives high electric performance in IR and BDV.

The insulating paste may preferably be applied again to cover electrodes except where conductivity is needed as seen in FIG. 2 (a). A process for manufacturing an electric module in this present invention preferably comprises steps of screen printing the insulating paste 1 of the present invention onto the inorganic substrate 2, and then printing conductive paste and printing the insulating paste again to cover the electrode. An electronic component mounts on the electrode where the insulating paste does not cover. The substrate with printed paste is heated to cure the paste. The insulating paste may also be applied on an electrode that comprises Ag, Cu, Au, Pt, Pd, Pd, Ni, Al, an Alloy of these materials or Indium tin oxide (ITO). A process to manufacture a printed electric module in this present invention preferably comprises steps of screen printing the insulating paste 1 of the present invention on an inorganic substrate 2, followed by printing conductive paste 3 and insulating paste 4 covering over the conductive paste. The timing of curing may be either every time after either the insulating paste or the conductive paste is printed or after applying some pastes are printed.

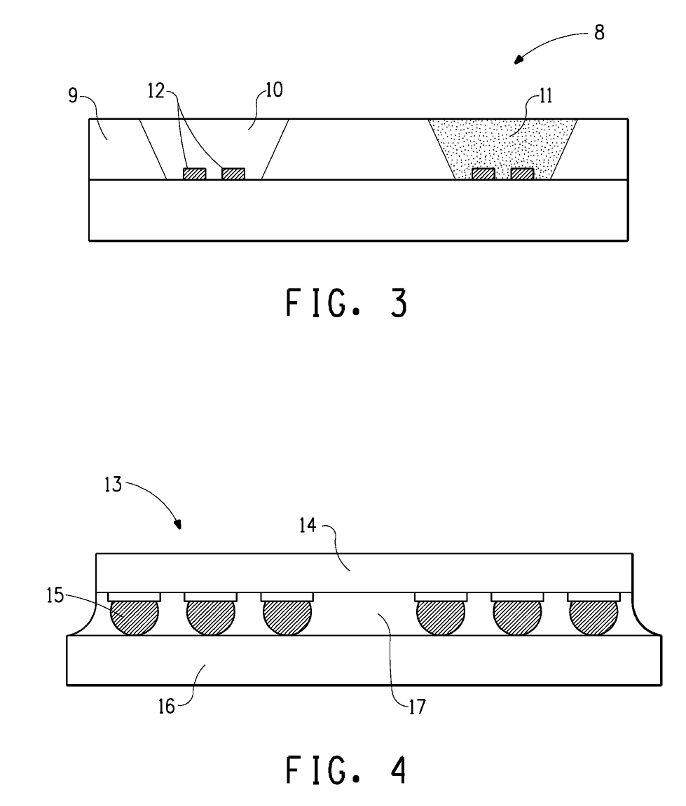

The insulating paste of this present invention may preferably be used as a sealant. For example, in FIG. 3 of an LED package, a sealant 10 is made by the insulation paste of this invention to encapsulate LED bare chips 12. LED package 8 is formed by mounting LED bare chips 12 in an indentation of a convex cavity 9 formed with plastic or ceramic followed by sealing with resin. The insulation paste preferably includes fluorescent material 11 that absorbs blue light from LED bare chip to emit red, green or yellow color to emit white light as a result. The fluorescent material refers to a material the absorbs energy from an electron beam, X-rays, ultraviolet rays or an electric field and the like, and efficiently emits a portion of this absorbed energy in the form of visible light. A white LED is mounted with an LED bare chip that emits blue light or near ultraviolet light emitted from the LED bare chip, and a fluorescent material that fulfills the role of emitting green light, yellow light and red light is mixed into the sealant. Furthermore, particles of an inorganic compound powder having a particle diameter of one to several tens of microns are typically used for the fluorescent material.

The insulating paste of this invention may be used as under-fill of a flip chip. The under-fill of FIG. 4 is an insulating paste of this invention. In a flip chip package 13, a conductor bare chip 14 is mounted on a substrate 16 with electrically conductive spherical bumps 15 interposed there between. Gaps between the bare chip 14 and the substrate 16 other than at the locations of the bumps 15 are filled with an under-fill 17. The under-fill 17 controls stress of solder joints generated due to differences in TCE between the bare chip 14 and a carrier. A cured under fill prevents damage resulting from a crack which is caused by the stress of TCE difference, thereby alleviating pressure on the bumps and improving the service life of the finished package.

### Composition of the Insulation Paste

### Heat-Curable Silicone Resin

The heat-curable silicone resin of the present invention is the polymerized product of polysiloxane oligomer consisting of silicon and oxygen and a functional group, and is represented by (R₂SiO)ₙ. wherein n is preferably 5 to 30 and n is more preferably 8 to 20. The R contained in the heat-curable silicone resin is preferably one or two functional groups selected from the group consisting of alkyl groups having 1 to 10 carbon atoms, namely a methyl group, ethyl group, propyl group, butyl group, pentyl group, hexyl group, heptyl group, octyl group, nonyl group or decyl group, or a phenyl group. The R is more preferably one or two functional groups selected from the group consisting of methyl group, ethyl group and propyl group. A heat-curable silicone resin containing such functional groups undergoes a hydrolysis-polymerization reaction at higher than 150 degrees C. and at a temperature of 450 degrees C. or lower, carbon-modified groups in the polysiloxane framework of the silicone resin are thermally desorbed. As a result, roughly 70% or more of the silicone resin consists of silicon oxides. The amount of inorganic substance in the silicone resin after curing can be measured using a differential thermal balance (thermogravimetry-differential thermal analysis: TG-DTA). The amount of silicone resin in the insulating paste is preferably 10% by weight to 99%, more preferably 15-50wt % by weight based on the total weight of the silicone resin and the inorganic filler.

Inorganic filler

This invention uses inorganic filler in combination with the silicone resin. The inorganic filler in this present invention is preferably an inorganic material which is not thermally decomposed under 350 degrees. The inorganic filler preferably contains one or a plurality of mica, talc, kaolinite (Al₂Si₂O₅(OH)₄), montmorillonite, titanic oxide (TiO₂), aluminum oxide (Al₂O₃), aluminum nitride (AlN), zirconium dioxide (ZrO₂), silicon carbide (SiC), Silica (SiO₂), barium titanate (BaTiO₃), geikielite (MgTiO₃), Tausonite (SrTiO₃) or boron nitride (BN). The amount of inorganic inorganic filler added is preferably 1% by weight to 90% by weight, more preferably 50% by weight to 85% by weight based on the total weight of the silicone resin and the inorganic filler.

### Solvent

The solvent of the present invention is an organic solvent for adjusting the viscosity of the heat-curable silicone resin. The solvent is preferably an organic solvent having a boiling point of 100 degrees C. or higher. More preferably, the solvent is hocarpineol, texanol, butylcarbitol, butylcarbitol acetate, dimethylsulfoxide, dioxane, terpineol, diethylene glycol dimethyl ether, diacetone alcohol, N-methylpyrrolidone, dimethylformamide or dimethylacetoamide. These solvents can be used alone or two or more types can be used after mixing. It is necessary to adjust the amount of solvent added so as to impart viscosity suitable for the application. For example, in the case of applying directly onto a metal substrate, the amount of solvent added is preferably 5% by weight to 50% by weight based on the weight of the silicone resin.

### Substrate

A substrate used in the electric module of the present invention is an inorganic substrate. The substrate preferably comprises an aluminum nitride substrate (AlN), an alumina substrate (AL₂O₃), a zirconia oxide substrate (ZrO), a mullite substrate (3Al₂O₃.2SiO₂), steatite (MgO.SiO₂), a ceramic glass substrate of ferrite glass or a metal substrate of stainless, aluminum, aluminum alloy, nickel, nickelic alloy or cupper. The substrate described above is preferably any of an aluminum nitride substrate, an alumina substrate, a zirconia oxide substrate (ZrO), a mullite substrate (3Al₂O₃.2SiO₂), steatite (MgO.SiO₂), a ceramic glass substrate of ferrite glass, or a metal substrate of stainless, aluminum (Al), aluminum alloy, nickel (Ni), nickelic alloy, cupper (Cu), glass or ceramic.

### EXAMPLES

### 1. Crack Test

The following provides an explanation of specific examples of the insulating paste of the present invention. Insulating pastes were made of mixture of heat-curable silicone resin, organic filler and solvent. The table 1 shows the percentage of each composition of example 1-6 and also their results if crack was observed. The details of each composition are as described below.

### Materials

Heat-Curable Silicone Resin

Heat-curable silicone resin (Silres® MK Powder, Wacker Asahikasei Silicone Co., Ltd.) which has methyl group was used. The silicone resin that was used in the examples is a non-volatile and powder type. This silicone resin has the following properties: softening point: 45 to 60 degrees C., bulk specific gravity (25 degrees C.): 0.5 to 0.65, curing conditions: 60 minutes at 200 degrees C.
Inorganic filler

Flake type of mica powder (MK-100, specific gravity 2.7 g/cm3, average diameter D=5 μm Co-op chemical Co., Ltd.,) spherical type of TiO2 powder (A100, ISHIHARA SANGYO KABUSHIKI-KAISYA, specific gravity 4.17 g/cm3, average particle diameter D50=0.3 μm), spherical type of Al2O3 powder (SUMITOMO CHEMICAL Co. Ltd., specific gravity 3.47 g/cm3 average particle diameter D50=1.3 μm) were used as a inorganic filler.
Solvent

Butyl carbitol acetate (Wako Pure Chemical Industries, Ltd.) was used as a solvent.

### Insulating Paste Manufacturing Process

After weighing the silver of the electrically conductive powder, the heat-curable silicone resin and the solvent at the respective composite ratios indicated in Table 1, the components were adequately stirred with a mixer and dispersed using a 3-roll mill. After adequately dispersing each component, the insulating paste was screen-printed onto a glass substrate. Glass substrates were used. The printing patterns consisted of a 10 mm length and 20 mm width square with 40 μm thickness. The substrates on which the insulating pastes were printed were dried in an oven under conditions of 150° C. for 15 minutes followed by curing in an oven under conditions of 220° C. for 20 minutes. In the example 7-10, a conductive adhesive with a pattern of a 5 mm length and 5 mm width square with 20 μm thickness was applied on the insulating layer. The BDV and IR were measured between the aluminum and silica substrate and the top of the electrical adhesive.

### Measurement

The presence of cracks was judged by observing the surface of the insulating layer after curing with a light microscope (magnification: 50×), and a judgment of “cracked” was made in the case one or more cracks were confirmed to be present. Results

The compositions of each of the examples and presence of the cracks occurring after heat-curing are shown in Table 1. Although cracks were not observed in those compositions in which mica, Al203 or TiO2 filler had been added to the silicone resin (Examples 1 to 11), cracks were observed in the composition in which filler was not added (Comparative example). It was therefore determined that in order to prevent the occurrence of cracks in the insulating layer of an inorganic substrate, it is preferable to add not only a silicone resin, but also an inorganic filler to the insulating paste.

TABLE 1

| | Silicone | Filler (wt %) | | | Results |
|---|---|---|---|---|---|
| | (wt %) | Mika | Al₂O₃ | TiO₂ | crack |
| Example 1 | 18 | — | 72 | 10 | no crack |
| Example 2 | 35 | — | 0 | 65 | no crack |
| Example 3 | 39 | — | 61 | — | no crack |
| Example 4 | 40 | 27 | — | 33 | no crack |
| Example 5 | 43 | 40 | — | 17 | no crack |
| Example 6 | 45 | 55 | — | — | no crack |
| Example 7 | 56 | 44 | — | — | no crack |
| Example 8 | 63 | 38 | — | — | no crack |
| Example 9 | 73 | 27 | — | — | no crack |
| Example 10 | 88 | 12 | — | — | no crack |
| Example 11 | 95 | 5 | — | — | no crack |
| Comparative example | 100 | — | — | — | cracked |

### 2. BDV and IR TEST

The BDV test

Next, BDV and IR tests were carried out on Examples 12 to 21. Table 2 shows the compositions of the insulating pastes along with the results of these tests. The pastes were prepared in the same manner as in Examples 1 to 6. However, the substrate is aluminum and silica alloy in Examples 12 to 21.

### Measurement Method

The BDV test (also called the insulating strength test) consists of the application of a voltage higher than rated voltage for a specific time between mutually insulated portions of a component part or between insulated portions and ground. The voltage is raised until the system fails which is indicated by short circuiting. This is used to observe whether the component part can operate safely at its rated voltage and withstand momentary over potentials due to switching, surges, and other similar phenomena. Although this test is often called a voltage breakdown or insulating strength test, it is not intended that this test cause insulation breakdown or that it be used for detecting corona. Rather it serves to determine whether insulating materials and spacings in the component part are adequate. When a component part is faulty in these respects, application of the test voltage will result in either disruptive discharge or deterioration. Disruptive discharge is evidenced by flashover (surface discharge), spark-over (air discharge), or breakdown (puncture discharge). Deterioration due to excessive leakage currents may change electrical parameters or physical characteristics. Insulating breakdown is reported in volts/cm of insulating thickness. Insulating layers are designed to have sufficient thickness to provide a margin of safety well below the breakdown of the electric. The test is conducted with a measure (TOS5101, KIKUSUI ELECTRONICS CORP.). The value shown in the table is an average of three measurements.

Insulation resistance (IR) is a measure of the ability of a charge capacitor to withstand leakage in DC current. Insulation resistance is a constant for any given insulating regardless of capacitance. The test is conducted with a measure (R8340A, Advantest Co. Ltd.). The value shown in the table is an average of three measurements.

### Results

Table 2 shows the compositions of the inorganic filler and silicone resin, the resulting BDV and IR values, and the presence or absence of cracks. Firstly, cracks were not observed in any of the examples. In contrast to the BDV value of a thick film insulating composition using a commercially available epoxy resin being 1.7 kv, insulating pastes containing silicone resin and inorganic filler demonstrated BDV values of 2.2 kv or more. A BDV value of 3 kv or more was obtained for the insulating pastes containing 58 wt % or more of inorganic filler (Examples 12 and 18). BDV values tended to be particularly high when Al2O3 was contained as the inorganic filler (Examples 12 and 14 to 18).
In addition, in contrast to electronic electric modules normally being required to have an IR value of 1×10¹¹ or more, IR values were obtained in all of the examples that exceeded this required IR value.

TABLE 2

| | Composition | | | | Results | | |
|---|---|---|---|---|---|---|---|
| | Silicone | Filler (wt %) | | | BDV | IR | |
| | (wt %) | Mika | Al₂O₃ | TiO₂ | (kv) | (10¹³) | crack |
| Example 12 | 18 | — | 72 | 10 | 4.4 | 2.5 | no |
| | | | | | | | crack |
| Example 13 | 35 | — | 0 | 65 | 3.2 | 1.3 | no |
| | | | | | | | crack |
| Example 14 | 38 | — | 48 | 14 | 5.5 | 25.0 | no |
| | | | | | | | crack |
| Example 15 | 39 | — | 61 | — | 5.4 | 1.3 | no |
| | | | | | | | crack |
| Example 16 | 40 | 10 | 50 | — | 5.5 | 4.6 | no |
| | | | | | | | crack |
| Example 17 | 41 | 20 | 39 | — | 4.0 | 1.6 | no |
| | | | | | | | crack |
| Example 18 | 42 | — | 58 | — | 5.5 | 5.1 | no |
| | | | | | | | crack |
| Example 19 | 45 | 55 | — | — | 2.8 | 3.0 | no |
| | | | | | | | crack |
| Example 20 | 56 | 44 | — | — | 2.2 | 1.4 | no |
| | | | | | | | crack |
| Example 21 | 77 | 23 | — | — | 2.4 | 20.0 | no |
| | | | | | | | crack |

### 3. Thermal Cycle Test

In Example 22, different compositions of insulating pastes were printed twice onto an alumina-silica alloy substrate to provide two insulating layers. A thermal cycle test was then carried out on the insulating layers printed on this substrate. The printing pattern measured 3.2×2.5 mm and had a thickness of 25 μm. The layer in direct contact with the SUS substrate was designated as the first layer, and the layer provided on the first layer was designated as the second layer. The compositions of the insulating pastes used to form each layer are shown in Table 3. The solvent was made to be half the weight of the silicone resin in the same manner as the other examples.

The substrates on which the insulating pastes were printed were dried in an oven under conditions of 150° C. for 15 minutes followed by curing in an oven under conditions of 220° C. for 20 minutes.

The thermal cycle test was carried out on this alumina-silica alloy substrate having two insulating layers over a range of 100 to 0 degrees C. followed by examining the insulating layers for the occurrence of cracks. The test method consisted of preparing boiling water at 100 degrees C. and cold water at 0 degrees C., and immersing the substrate in water at each temperature for 10 seconds each. Immersing in both the 100 degree C. and 0 degree C. water was taken to constitute one cycle, and testing was carried out for 50 cycles. As a result of this thermal cycle test, cracks were not observed to occur in the two insulating layers. Thus, the two insulating layers of Example 22 are able to withstand sudden changes in temperature. The use of an insulating paste containing silicone resin and mica for the first layer and an insulating paste containing Al2O3 for the second layer allowed the obtaining of a electric module having strong resistance to thermal cycling.

On the basis of the examples described above, the insulating paste of this invention demonstrates the effects described below. Firstly, the insulating paste of this invention shows excellent adhesiveness to an inorganic substrate. It also contributes to the production of highly reliable electric modules by preventing cracks. In addition, simultaneous to preventing cracks, the insulating paste of this invention containing a silicone resin and inorganic filler satisfies the IR typically required of insulating layers while also having superior BDV.

Since the thick film of cured silicone resin has excellent thermal conductivity according to a past experiment (Silicone resin conductive paste: 64 W/m·K, Epoxy resin conductive thick film: 4-5 W/m·K), the insulating paste of this invention render longer life time on a electric module. In addition, although epoxy resins are typically hygroscopic and have inferior weather resistance, silicone resins are known to have low hygroscopicity and demonstrate superior weather resistance. Thus, the electronic electric module of this invention can be preferably used even when used outdoors where changes in environmental conditions, such as low temperatures, high temperatures, dryness or high humidity, are expected. The insulating paste is heat-curable at a low temperature and greatly contributes to cost reduction in a manufacturing process of an electric module. The insulating paste is heat-curable at a low temperature and greatly contributes to cost reduction in a manufacturing process of an electric module.

What is claimed is:

1. An insulating paste for an electric module comprising heat-curable silicone resin, inorganic filler and solvent.

2. The insulating paste according to claim 1, wherein the heat-curable silicone resin contains functional groups of alkyl group having 1 to 10 carbon atoms or phenyl group.

3. The insulating paste according to claim 1, wherein the amount of the heat-curable silicone resin is 10 wt % to 99 wt % based on total weight of the silicone resin and the inorganic filler.

4. The insulating paste according to claim 1, wherein the inorganic filler is one or more types of inorganic selected from the group consisting of mica, talc, kaolinite (Al₂Si₂O₅(OH4), montmorillonite, titanic oxide (TiO₂), aluminum oxide (Al₂O₃), aluminum nitride (AlN), zirconium dioxide (ZrO₂), and silicon carbide (SiC), Silica (SiO₂), barium titanate (BaTiO₃), geikielite (MgTiO₃), silicon carbide (SiC), Silica (SiO₂), barium titanate (BaTiO₃), geikielite (MgTiO₃), Tausonite (SrTiO₃) and Boron nitride (BN)

5. An electric module comprising:
an inorganic substrate;
an insulating layer formed on the inorganic substrate and comprising cured resin including polysiloxane skeleton and inorganic filler dispersed in the cured resin; and
an electrode formed on the insulating layer.

6. An electric module according to the claim 5, wherein insulating layer covers an electrode.

7. An electric module according to the claim 5, wherein the insulating layer comprises a first insulating layer and a second insulating layer, wherein the first layer on the inorganic substrate comprises cured resin including polysiloxane skeleton and inorganic filler that is one or more of mica, talc or their mixture, and the second insulating layer on the first insulating layer comprises cured resin including polysiloxane skeleton and inorganic filler that is one or more of kaolinite (Al₂Si₂O₅(OH)₄), montmorillonite, titanic oxide (TiO₂), aluminum oxide (Al₂O₃), aluminum nitride (AlN), zirconium dioxide (ZrO₂), and silicon carbide (SiC), Silica (SiO₂), barium titanate (BaTiO₃), geikielite (MgTiO₃) and Tausonite (SrTiO₃).

8. An electric module according to claim 5, wherein the substrate is any of s an aluminum nitride substrate (AlN), an alumina substrate (AL₂O₃), a zirconia oxide substrate (ZrO), a mullite substrate (3Al₂O₃.2SiO₂), steatite (MgO.SiO₂), a ceramic glass substrate of ferrite glass, or a metal substrate of stainless, aluminum, aluminum alloy, nickel, nickelic alloy or cupper.
